(19) United States
(12) Patent Application Publication
(10) Pub. No.: US 2023/0141150 A1
(43) Pub. Date: May 11, 2023

(54) PROCESSING APPARATUS, PROCESSING METHOD, AND NON-TRANSITORY STORAGE MEDIUM

(71) Applicant: NEC Corporation, Minato-ku, Tokyo (JP)

(72) Inventors: Yu NABETO, Tokyo (JP); Katsumi KIKUCHI, Tokyo (JP); Takami SATO, Tokyo (JP); Soma SHIRAISHI, Tokyo (JP)

(73) Assignee: NEC Corporation, Minato-ku, Tokyo (JP)

(21) Appl. No.: 17/918,405

(22) PCT Filed: Apr. 21, 2020
(86) PCT No.: PCT/JP2020/017231

§ 371 Date: Oct. 12, 2022

(51) Int. Cl. G06V 10/22; G06V 20/52; G06V 10/14; G06V 10/74

(52) U.S. Cl. CPC G06V 10/23; G06V 20/52; G06V 10/14; G06V 10/74

(57) ABSTRACT

The present invention provides a processing apparatus (10) including: an acquisition unit (11) that acquires an image generated by a plurality of cameras for photographing a product picked up by a customer; a recognition unit (12) that recognizes the product, based on each of a plurality of images generated by the plurality of cameras; and a determination unit (13) that determines a final recognition result, based on a plurality of recognition results based on each of the plurality of images, and a size of a region where the product is present within each of the plurality of images.

### TECHNICAL FIELD

The present invention relates to a processing apparatus, a processing method, and a program.

### BACKGROUND ART

Non-Patent Documents 1 and 2 disclose a store system in which settlement processing (such as product registration and payment) at a cash register counter is eliminated. In the technique, a product picked up by a customer is recognized based on an image generated by a camera for photographing inside a store, and settlement processing is automatically performed based on a recognition result at a timing when the customer goes out of the store.

Patent Document 1 discloses a technique of performing image recognition with respect to a surgical image generated by each of three cameras, computing a degree of surgical field exposure of each image, based on a result of the image recognition, selecting an image in which the degree of surgical field exposure is largest from among three surgical images, and displaying the selected image on a display.

### RELATED DOCUMENT

### Patent Document

[Patent Document 1] International Publication No. WO2019/130889

### Non-Patent Document

[Non-Patent Document 1] Takuya MIYATA, “Structure of Amazon Go Supermarket without Cash Register to be Achieved by ‘Camera and Microphone’”, [online], Dec. 10, 2016, [search on Dec. 6, 2019], the Internet <URL: https//www.huffingtonpost.jp/tak-miyata/amazon-go_b_13521384.html>
[Non-Patent Document 2] “NEC, Opened Cash Registerless Store ‘NEC SMART STORE’ in Main Office—Utilization of Face Recognition, Settlement Simultaneously when Leaving Store”, [online]. Feb. 28, 2020, [search on Mar. 27, 2020], the Internet <URL: https://japan.cnet.com/article/35150024/>

### DISCLOSURE OF THE INVENTION

### Technical Problem

A technique for accurately recognizing a product picked up by a customer has been desired. For example, in a store system in which settlement processing (such as product registration and payment) at a cash register counter is eliminated, which is described in Non-Patent Documents 1 and 2, a technique for accurately recognizing a product picked up by a customer is necessary. In addition to the above, the above technique is useful also in a case where a customer's behavior within a store is investigated for a purpose of a preference survey of a customer, a marketing research, and the like.

An object of the present invention is to provide a technique for accurately recognizing a product picked up by a customer.

### Solution to Problem

The present invention provides a processing apparatus including:

an acquisition unit that acquires an image generated by a plurality of cameras for photographing a product picked up by a customer;

a recognition unit that recognizes the product, based on each of a plurality of images generated by the plurality of cameras; and

a determination unit that determines the final recognition result, based on a plurality of recognition results based on each of the plurality of images, and a size of a region where the product is present within each of the plurality of images.

Further, the present invention provides a processing method including, by a computer:

acquiring an image generated by a plurality of cameras for photographing a product picked up by a customer;

recognizing the product, based on each of a plurality of images generated by the plurality of cameras; and

determining the final recognition result, based on a plurality of recognition results based on each of the plurality of images, and a size of a region where the product is present within each of the plurality of images.

Further, the present invention provides a program causing a computer to execute:

an acquisition unit that acquires an image generated by a plurality of cameras for photographing a product picked up by a customer;

a recognition unit that recognizes the product, based on each of a plurality of images generated by the plurality of cameras; and

a determination unit that determines the final recognition result, based on a plurality of recognition results based on each of the plurality of images, and a size of a region where the product is present within each of the plurality of images.

### Advantageous Effects of Invention

The present invention achieves a technique for accurately recognizing a product picked up by a customer.

### BRIEF DESCRIPTION OF THE DRAWINGS

FIG. 1 is a diagram illustrating one example of a hardware configuration of a processing apparatus according to the present example embodiment.

FIG. 2 is one example of a functional block diagram of the processing apparatus according to the present example embodiment.

FIG. 3 is a diagram illustrating an installation example of a camera according to the present example embodiment.

FIG. 4 is a diagram illustrating an installation example of a camera according to the present example embodiment.

FIG. 5 is a diagram illustrating one example of an image to be processed by the processing apparatus according to the present example embodiment.

FIG. 6 is a flowchart illustrating one example of a flow of processing of the processing apparatus according to the present example embodiment.

FIG. 7 is a flowchart illustrating one example of a flow of processing of the processing apparatus according to the present example embodiment.

FIG. 8 is a flowchart illustrating one example of a flow of processing of the processing apparatus according to the present example embodiment.

FIG. 9 is a flowchart illustrating one example of a flow of processing of the processing apparatus according to the present example embodiment.

### DESCRIPTION OF EMBODIMENTS

### First Example Embodiment

“Overview”

In a case where a size of a product picked up by a customer within an image (size of a region occupied by the product within an image) is small, it is difficult to extract, from the image, a feature value of an external appearance of the product. Consequently, accuracy of product recognition may be lowered. Therefore, in view of an aspect of improving accuracy of product recognition, it is preferable to photograph a product in such a way that a size of the product increases as much as possible within an image, and perform product recognition, based on the image.

In view of the above, according to the present example embodiment, a product picked up by a customer is photographed by a plurality of cameras at a plurality of positions and in a plurality of directions. Configuring as described above increases a possibility with which the product can be photographed by any of the cameras in such a way that a size of the product sufficiently increases within an image, regardless of a display position of the product being picked up, a pose and a height of a customer, a way of picking up the product, a pose when a customer is holding the product, and the like.

A processing apparatus analyzes each of a plurality of images generated by a plurality of cameras, and recognizes a product (product picked up by a customer) included in each image. Further, the processing apparatus outputs, as a final recognition result, a recognition result based on an image in which a region (size within an image) where a product is present is largest within each of a plurality of images.

“Hardware Configuration”

Next, one example of a hardware configuration of the processing apparatus is described.

Each functional unit of the processing apparatus is achieved by any combination of hardware and software mainly including a central processing unit (CPU) of any computer, a memory, a program loaded in a memory, a storage unit (capable of storing, in addition to a program stored in advance at a shipping stage of an apparatus, a program downloaded from a storage medium such as a compact disc (CD), a server on the Internet, and the like) such as a hard disk storing the program, and an interface for network connection. Further, it is understood by a person skilled in the art that there are various modification examples as a method and an apparatus for achieving the configuration.

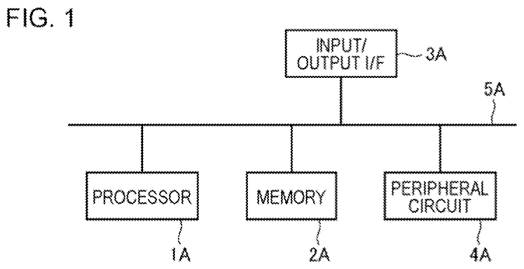

FIG. 1 is a block diagram illustrating a hardware configuration of the processing apparatus. As illustrated in FIG. 1, the processing apparatus includes a processor 1A, a memory 2A, an input/output interface 3A, a peripheral circuit 4A, and a bus 5A. The peripheral circuit 4A includes various modules. The processing apparatus may not include the peripheral circuit 4A. Note that, the processing apparatus may be constituted of a plurality of apparatuses that are physically and/or logically separated, or may be constituted of one apparatus that is physically and/or logically integrated. In a case where the processing apparatus is constituted of a plurality of apparatuses that are physically and/or logically separated, each of the plurality of apparatuses can include the above-described hardware configuration.

The bus 5A is a data transmission path along which the processor 1A, the memory 2A, the peripheral circuit 4A, and the input/output interface 3A mutually transmit and receive data. The processor 1A is, for example, an arithmetic processing apparatus such as a CPU and a graphics processing unit (GPU). The memory 2A is, for example, a memory such as a random access memory (RAM) and a read only memory (ROM). The input/output interface 3A includes an interface for acquiring information from an input apparatus, an external apparatus, an external server, an external sensor, a camera, and the like, an interface for outputting information to an output apparatus, an external apparatus, an external server, and the like, and the like. The input apparatus is, for example, a keyboard, a mouse, a microphone, a physical button, a touch panel, and the like. The output apparatus is, for example, a display, a speaker, a printer, a mailer, and the like. The processor 1A can issue a command to each module, and perform an arithmetic operation, based on these arithmetic operation results.

“Functional Configuration”

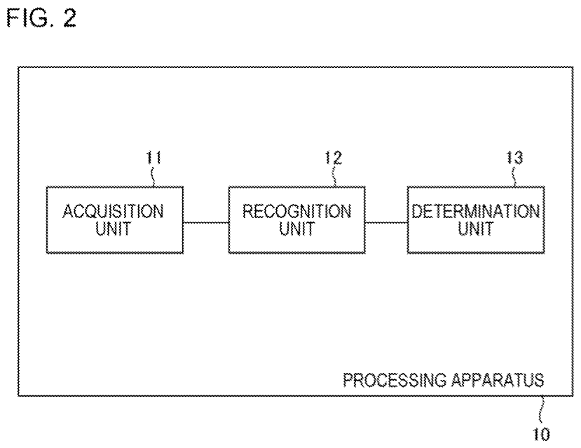

FIG. 2 illustrates one example of a functional block diagram of a processing apparatus 10. As illustrated in FIG. 2, the processing apparatus 10 includes an acquisition unit 11, a recognition unit 12, and a determination unit 13.

The acquisition unit 11 acquires an image generated by a plurality of cameras for photographing a product picked up by a customer. An input of an image to the acquisition unit 11 may be performed by real-time processing, or may be performed by batch processing. Which processing is used can be determined, for example, according to a usage content of a recognition result.

Herein, a plurality of cameras are described. In the present example embodiment, a plurality of cameras (two or more cameras) are installed in such a way that a product picked up by a customer can be photographed in a plurality of directions and at a plurality of positions. For example, a plurality of cameras may be installed at a position and in an orientation in which a product taken out of each product display shelf is photographed for each product display shelf. A camera may be installed on a product display shelf, may be installed on a ceiling, may be installed on a floor, may be installed on a wall surface, or may be installed at another location. Note that, an example in which a camera is installed for each product display shelf is merely one example, and the present example embodiment is not limited thereto.

A camera may photograph a moving image constantly (e.g., during business hours), or may continuously photograph a still image at a time interval larger than a frame interval of a moving image, or these photographing operations may be performed only during a time when a person present at a predetermined position (such as in front of a product display shelf) is detected by a human sensor or the like.

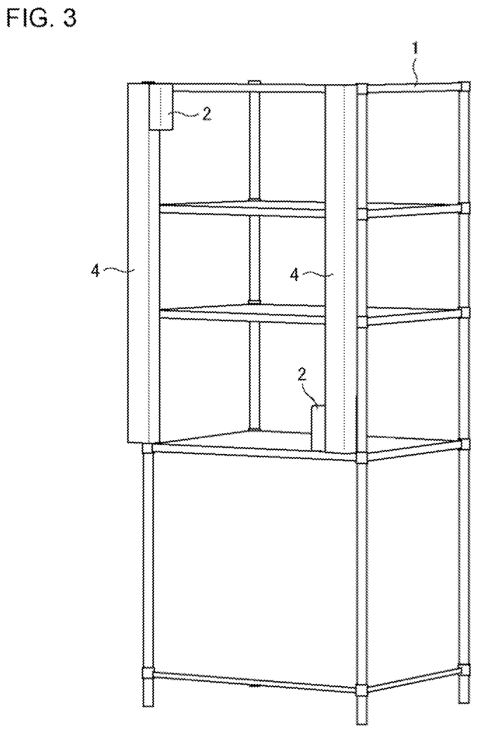

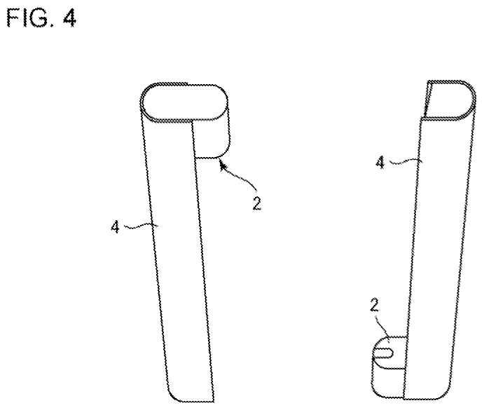

Herein, one example of camera installation is described. Note that, a camera installation example described herein is merely one example, and the present example embodiment is not limited thereto. In an example illustrated in FIG. 3, two cameras 2 are installed for each product display shelf 1. FIG. 4 is a diagram in which a frame 4 in FIG. 3 is extracted. A camera 2 and an illumination (not illustrated) are provided for each of two components constituting the frame 4.

A light irradiation surface of the illumination extends in one direction, and the illumination includes a light emitting unit, and a cover for covering the light emitting unit. The illumination mainly irradiates light in a direction orthogonal to an extending direction of the light 5 irradiation surface. The light emitting unit includes a light emitting element such as a LED, and irradiates light in a direction in which the illumination is not covered by the cover. Note that, in a case where the light emitting element is a LED, a plurality of LEDs are aligned in a direction (up-down direction in the figure) in which the illumination extends.

Further, the camera 2 is provided at one end of a component of the linearly extending frame 4, and has a photographing range in a direction in which light of the illumination is irradiated. For example, in a component of the left-side frame 4 in FIG. 4, the camera 2 has a photographing range in a range extending downward and a range extending obliquely right downward. Further, in a component of the right-side frame 4 in FIG. 4, the camera 2 has a photographing range in a range extending upward and a range extending obliquely left upward.

As illustrated in FIG. 3, the frame 4 is mounted on a front surface frame (or a front surface of a side wall on both sides) of the product display shelf 1 constituting a product placement space. One of components of the frame 4 is mounted on one of the front surface frames in an orientation in which the camera 2 is located at a lower position, and the other of the components of the frame 4 is mounted on the other of the front surface frames in an orientation in which the camera 2 is located at an upper position. Further, the camera 2 mounted on one of the components of the frame 4 photographs an upper range and an obliquely upper range in such a way that an opening portion of the product display shelf 1 is included in a photographing range. On the other hand, the camera 2 mounted on the other of the components of the frame 4 photographs a lower range and an obliquely lower range in such a way that the opening portion of the product display shelf 1 is included in a photographing range. This configuration allows the two cameras 2 to photograph an entire range of the opening portion of the product display shelf 1. Consequently, it becomes possible to photograph, by the two cameras 2, a product taken out of the product display shelf 1 (product picked up by a customer).

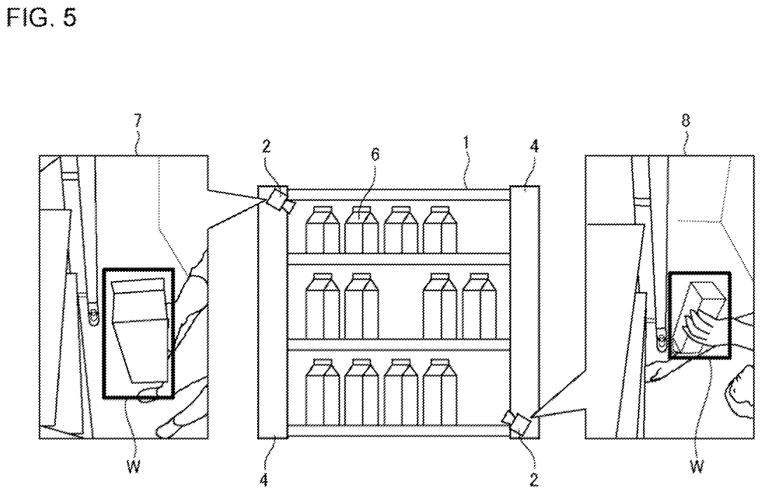

For example, in a case where a configuration illustrated in FIGS. 3 and 4 is adopted, as illustrated in FIG. 5, a size of a product 6 within an image generated by each of the two cameras 2 may differ depending on which position of the product display shelf 1, the displayed product 6 is taken out of. A product 6 displayed on an upper row and on the more left side in FIG. 5 has a larger size within a first image 7 to be generated by the camera 2 located at an upper left position in FIG. 5, and has a smaller size within a second image 8 to be generated by the camera 2 located at a lower right position in FIG. 5. Further, a product 6 displayed on a lower row and on the righter side in FIG. 5 has a larger size within the second image 8 to be generated by the camera 2 located at the lower right position in FIG. 5, and has a smaller size within the first image 7 to be generated by the camera 2 located at the upper left position in FIG. 5. In FIG. 5, a same product present within the first image 7 and the second image 8 is surrounded by a frame W. As illustrated in FIG. 5, sizes of the product within the images may differ from each other.

Referring back to FIG. 2, the recognition unit 12 recognizes a product, based on each of the plurality of images generated by the plurality of cameras.

Herein, a specific example of recognition processing to be performed for each image is described. First, the recognition unit 12 collates between a feature value of an external appearance of an object extracted from an image, and a feature value of an external appearance of each of a plurality of products registered in advance, and computes, based on a collation result, a degree of reliability (referred to as a degree of certainty, a degree of similarity, and the like) with which an object included in an image for each product is each product. The degree of reliability is computed based on the number of matching feature values, a ratio of the number of matching feature values with respect to the number of feature values registered in advance, and the like.

Further, the recognition unit 12 determines a recognition result, based on a computed degree of reliability. The recognition result becomes, for example, product identification information of a product included in an image. For example, the recognition unit 12 may determine a product having a highest degree of reliability, as a product included in the image, or may determine a recognition result, based on another criterion. Thus, a recognition result for each image is acquired.

Note that, an estimation model (class classifier) for recognizing a product within an image may be generated, in advance, by machine learning based on training data in which an image of each of a plurality of products, and identification information (label) of each product are associated with each other. Further, the recognition unit 12 may achieve product recognition by inputting an image acquired by the acquisition unit 11 to the estimation model.

The recognition unit 12 may input an image itself acquired by the acquisition unit 11 to an estimation model, or may input a processed image to an estimation model after processing is performed for an image acquired by the acquisition unit 11.

Herein, one example of processing is described. First, the recognition unit 12 recognizes an object present within an image, based on a conventional object recognition technique. Further, the recognition unit 12 cuts out, from the image, a partial region where the object is present, and inputs an image in the cut-out partial region to an estimation model. Note that, object recognition may be performed for each of a plurality of images acquired by the acquisition unit 11, or may be performed for one integrated image, after a plurality of images acquired by the acquisition unit 11 are integrated. In the latter case, the number of image files to be subjected to image recognition is reduced, and processing efficiency is improved.

A determination unit 13 determines and outputs a final recognition result (product identification information and the like), based on a plurality of recognition results (product identification information and the like) based on each of a plurality of images.

More specifically, the determination unit 13 computes a size of a region where a product is present within each of a plurality of images, and determines and outputs, as a final recognition result, a recognition result based on an image whose size is largest.

The size may be indicated by an area of a region where a product is present, may be indicated by a length of an outer circumference of the region, or may be indicated by another parameter. The area and the length can be indicated by, for example, the number of pixels, but the present example embodiment is not limited thereto.

A region where a product is present may be a rectangular region including the product and its periphery, or may be a region of a shape along a contour of the product where only the product is present. Which one of these is adopted can be determined based on, for example, a method of detecting a product (object) within an image. For example, in a case where a method of determining whether a product (object) is present for each rectangular region within an image is adopted, a region where the product is present can be set as a rectangular region including the product and its periphery. On the other hand, in a case where a method of detecting a pixel region where a detection target is present, which is called a semantic segmentation or an instance segmentation, is adopted, a region where a product is present can be set as a region of a shape along a contour of the product where only the product is present.

Note that, in the present example embodiment, a processing content for a final recognition result (product identification information of a recognized product) output from the determination unit 13 thereafter is not specifically limited.

For example, a final recognition result may be utilized by settlement processing in a store system in which settlement processing (such as product registration and payment) at a cash register counter is eliminated, as disclosed in Non-Patent Documents 1 and 2. In the following, one example is described.

First, a store system registers product identification information (final recognition result) of a recognized product in association with information for determining a customer who has picked up the product. For example, a camera for photographing a face of a customer who has picked up a product may be installed in a store, and a store system may extract, from an image generated by the camera, a feature value of an external appearance of the face of the customer. Further, the store system may register product identification information of a product picked up by the customer, and other product information (such as a unit price, and a product name) in association with a feature value of an external appearance of the face (information for determining a customer). The other product information can be acquired from a product master (information in which product identification information, and other product information are associated with each other), which is stored in the store system in advance.

In addition to the above, customer identification information (such as a membership number and a name) of a customer, and a feature value of an external appearance of a face may be registered in advance in association with each other at any location (such as a store system, and a center server). Further, when extracting, from an image including a face of a customer who has picked up a product, a feature value of an external appearance of the face of the customer, the store system may determine customer identification information of the customer, based on the information registered in advance. Further, the store system may register product identification information of a product picked up by the customer and other product information in association with the determined customer identification information.

Further, the store system computes a settlement amount, based on a registration content, and performs settlement processing. For example, settlement processing is performed at a timing when a customer leaves a store through a gate, a timing when a customer goes out of a store through an exit, or the like. Detection of these timings may be achieved by detecting that a customer leaves a store by way of an image generated by a camera installed at a gate or an exit, may be achieved by inputting, to an input apparatus (such as a reader for performing near field communication) installed at a gate or an exit, customer identification information of a customer who leaves a store, or may be achieved by another method. Details on settlement processing may be settlement processing by a credit card based on credit card information registered in advance, may be settlement based on pre-charged money, or may be other than the above.

As another usage scene on a final recognition result (product identification information of a recognized product) output from the determination unit 13, a preference survey of a customer, a marketing research, and the like are exemplified. For example, it is possible to analyze a product and the like in which each customer is interested by registering a product picked up by each customer in association with each customer. Further, it is possible to analyze in which product, a customer is interested by registering that the customer has picked up a product for each product. Furthermore, it is possible to analyze an attribute of a customer who is interested in each product by estimating an attribute (such as a gender, an age group, and a nationality) of a customer by utilizing a conventional image analysis technique, and registering an attribute of a customer who has picked up each product.

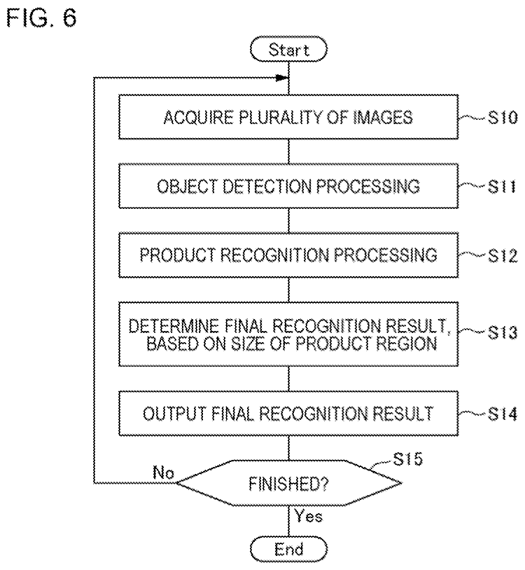

Next, one example of a flow of processing of the processing apparatus 10 is described by using a flowchart in FIG. 6.

First, the acquisition unit 11 acquires an image generated by a plurality of cameras for photographing a product picked up by a customer (S10). For example, the acquisition unit 11 acquires the first image 7 and the second image 8 generated by the two cameras 2 installed on the product display shelf 1 illustrated in FIGS. 3 to 5.

Next, the recognition unit 12 detects an object included in each of the plurality of images generated by the plurality of cameras (S11).

Next, the recognition unit 12 performs processing of recognizing a product included in each of the plurality of images generated by the plurality of cameras (S12). For example, the recognition unit 12 cuts out, from each of the plurality of images generated by the plurality of cameras, a partial region including a detected object. Then, the recognition unit 12 performs product recognition processing by inputting, to an estimation model (class classifier) prepared in advance, an image in the cut-out partial region.

Next, the determination unit 13 determines a final recognition result, based on a plurality of recognition results based on each of the plurality of images in S12 (S13). Specifically, the determination unit 13 computes a size of a region where a product (object) is present within each of the plurality of images, based on an object detection result in S11, and determines a recognition result based on an image whose size is largest, as a final recognition result.

Next, the determination unit 13 outputs the determined final recognition result (S14).

Thereafter, similar processing is repeated.

### Advantageous Effect

In the processing apparatus 10 according to the present example embodiment described above, a plurality of images generated by a plurality of cameras for photographing a product picked up by a customer at a plurality of positions and in a plurality of directions are acquired as an analysis target. Therefore, a possibility of capable of acquiring, as an analysis target, an image of a product whose size is sufficiently large increases, regardless of a display position of the product being picked up, a pose and a height of a customer, a way of picking up the product, a pose when a customer is holding the product, and the like.

Further, the processing apparatus 10 determines one image suitable for product recognition from among the plurality of images generated by the plurality of cameras, and adopts a recognition result on a product based on the determined image. Specifically, the processing apparatus 10 determines an image of a product whose size is largest, and adopts a recognition result on the product based on the image.

According to the processing apparatus 10 as described above, product recognition can be performed based on an image of a product whose size is sufficiently large, and a result of the product recognition can be output. Consequently, it becomes possible to accurately recognize a product picked up by a customer.

### Second Example Embodiment

A processing apparatus 10 according to a present example embodiment determines a final recognition result, based on a size of a region where a product is present within each of a plurality of images, in a case where recognition results different from each other are included in a plurality of recognition results based on each of the plurality of images. Further, in a case where the plurality of recognition results based on each of the plurality of images match, the processing apparatus 10 determines the matched recognition result, as a final recognition result.

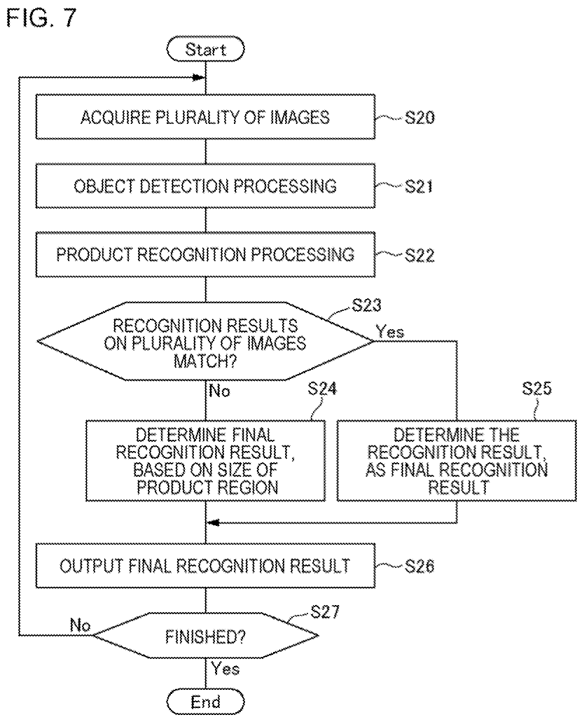

One example of a flow of processing of the processing apparatus 10 is described by using a flowchart in FIG. 7.

First, an acquisition unit 11 acquires an image generated by a plurality of cameras for photographing a product picked up by a customer (S20). For example, the acquisition unit 11 acquires a first image 7 and a second image 8 generated by two cameras 2 installed on a product display shelf 1 illustrated in FIGS. 3 to 5.

Next, a recognition unit 12 detects an object included in each of the plurality of images generated by the plurality of cameras (S21).

Next, the recognition unit 12 performs processing of recognizing a product included in each of the plurality of images generated by the plurality of cameras (S22). For example, the recognition unit 12 cuts out, from each of the plurality of images generated by the plurality of cameras, a partial region including a detected object. Then, the recognition unit 12 performs product recognition processing by inputting, to an estimation model (class classifier) prepared in advance, an image in the cut-out partial region.

Next, a determination unit 13 determines whether a plurality of recognition results based on each of the plurality of images match (S23).

In a case where the plurality of recognition results match (Yes in S23), the determination unit 13 determines the matched recognition result, as a final recognition result.

On the other hand, in a case where the plurality of recognition results do not match (No in S23), specifically, in a case where recognition results different from each other are included in the plurality of recognition results based on each of the plurality of images, the determination unit 13 determines a final recognition result, based on a size of a region where a product (object) is present within each of the plurality of images (S24). Specifically, the determination unit 13 computes a size of a region where a product (object) is present within each of the plurality of images, based on an object detection result in S21, and determines a recognition result based on an image whose size is largest, as a final recognition result.

Next, the determination unit 13 outputs the determined final recognition result (S26).

Thereafter, similar processing is repeated.

Other configurations of the processing apparatus 10 are similar to those of the first example embodiment.

In the processing apparatus 10 according to the present example embodiment described above, an advantageous effect similar to that of the first example embodiment is achieved. Further, in the processing apparatus 10 according to the present example embodiment, it is possible to reduce the number of times of performing processing of computing a size of a region where a product (object) is present within each of a plurality of images, and processing of determining a final recognition result, based on a result of the computation. Consequently, processing load on a computer is reduced.

### Third Example Embodiment

A processing apparatus 10 according to a present example embodiment determines a final recognition result, based on a size of a region where a product is present within each of a plurality of images, in a case where a difference between a highest degree of reliability and a second highest degree of reliability is less than a threshold value (design matter) among degrees of reliability of each of a plurality of recognition results based on each of the plurality of images, and it is also assumed that a recognition result having a highest degree of reliability may be incorrect. Further, in a case where a difference between a highest degree of reliability and a second highest degree of reliability is equal to or more than the threshold value among degrees of reliability of each of a plurality of recognition results based on each of the plurality of images, and it is hardly assumed that a recognition result having a highest degree of reliability may be incorrect, the processing apparatus 10 determines the recognition result having the highest degree of reliability, as a final recognition result. The degree of reliability of a recognition result is as described in the first example embodiment.

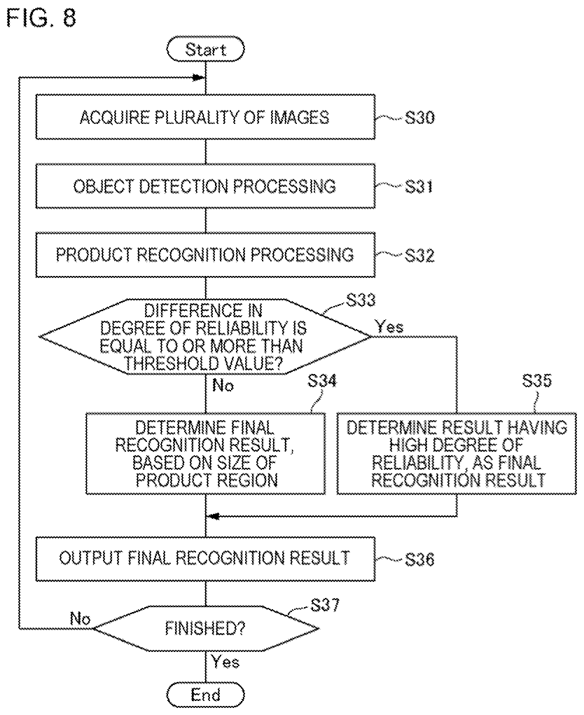

One example of a flow of processing of the processing apparatus 10 is described by using a flowchart in FIG. 8.

First, an acquisition unit 11 acquires an image generated by a plurality of cameras for photographing a product picked up by a customer (S30). For example, the acquisition unit 11 acquires a first image 7 and a second image 8 generated by two cameras 2 installed on a product display shelf 1 illustrated in FIGS. 3 to 5.

Next, a recognition unit 12 detects an object included in each of the plurality of images generated by the plurality of cameras (S31).

Next, the recognition unit 12 performs processing of recognizing a product included in each of the plurality of images generated by the plurality of cameras (S32). For example, the recognition unit 12 cuts out, from each of the plurality of images generated by the plurality of cameras, a partial region including a detected object. Then, the recognition unit 12 performs product recognition processing by inputting, to an estimation model (class classifier) prepared in advance, an image in the cut-out partial region.

Next, a determination unit 13 determines whether a difference between a highest degree of reliability and a second highest degree of reliability is equal to or more than a threshold value among degrees of reliability of each of the plurality of recognition results based on each of the plurality of images (S33). Note that, in a case where only two recognition results based on two images are acquired, processing of determining whether a difference in degree of reliability between the two recognition results is equal to or more than a threshold value is performed.

In a case where the difference is equal to or more than the threshold value (Yes in S33), the determination unit 13 determines the recognition result having the highest degree of reliability, as a final recognition result (S35).

On the other hand, in a case where the difference is less than the threshold value (No in S33), the determination unit 13 determines a final recognition result, based on a size of a region where a product (object) is present within each of the plurality of images (S34). Specifically, the determination unit 13 computes a size of a region where a product (object) is present within each of the plurality of images, based on an object detection result in S31, and determines a recognition result based on an image whose size is largest, as a final recognition result.

Next, the determination unit 13 outputs the determined final recognition result (S36).

Thereafter, similar processing is repeated.

Other configurations of the processing apparatus 10 are similar to those of the first example embodiment.

In the processing apparatus 10 according to the present example embodiment described above, an advantageous effect similar to that of the first example embodiment is achieved. Further, in the processing apparatus 10 according to the present example embodiment, it is possible to reduce the number of times of performing processing of computing a size of a region where a product (object) is present within each of a plurality of images, and processing of determining a final recognition result, based on a result of the computation. Consequently, processing load on a computer is reduced.

### Fourth Example Embodiment

A processing apparatus 10 according to a present example embodiment has a configuration in which configurations of the second example embodiment and the third example embodiment are combined.

Specifically, the processing apparatus 10 according to the present example embodiment determines a final recognition result, based on a size of a region where a product is present within each of the plurality of images, in a case where recognition results different from each other are included in a plurality of recognition results based on each of a plurality of images. Further, in a case where the plurality of recognition results based on each of the plurality of images match, the processing apparatus 10 determines the matched recognition result, as a final recognition result.

Further, the processing apparatus 10 according to the present example embodiment determines a final recognition result, based on a size of a region where a product is present within each of the plurality of images, in a case where a difference between a highest degree of reliability and a second highest degree of reliability is less than a threshold value (design matter) among degrees of reliability of each of a plurality of recognition results based on each of the plurality of images. Further, in a case where a difference between a highest degree of reliability and a second highest degree of reliability is equal to or more than the threshold value among degrees of reliability of each of a plurality of recognition results based on each of the plurality of images, the processing apparatus 10 determines the recognition result having the highest degree of reliability, as a final recognition result.

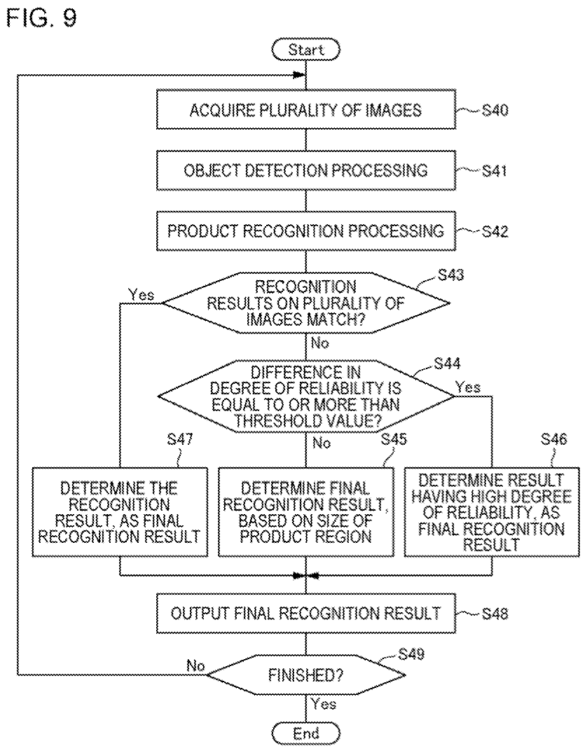

One example of a flow of processing of the processing apparatus 10 is described by using a flowchart in FIG. 9.

First, an acquisition unit 11 acquires an image generated by a plurality of cameras for photographing a product picked up by a customer (S40). For example, the acquisition unit 11 acquires a first image 7 and a second image 8 generated by two cameras 2 installed on a product display shelf 1 illustrated in FIGS. 3 to 5.

Next, a recognition unit 12 detects an object included in each of the plurality of images generated by the plurality of cameras (S41).

Next, the recognition unit 12 performs processing of recognizing a product included in each of the plurality of images generated by the plurality of cameras (S42). For example, the recognition unit 12 cuts out, from each of the plurality of images generated by the plurality of cameras, a partial region including a detected object. Then, the recognition unit 12 performs product recognition processing by inputting, to an estimation model (class classifier) prepared in advance, an image in the cut-out partial region.

Next, a determination unit 13 determines whether the plurality of recognition results based on each of the plurality of images match (S43).

In a case where the plurality of recognition results match (Yes in S43), the determination unit 13 determines the matched recognition result, as a final recognition result.

On the other hand, in a case where the plurality of recognition results do not match (No in S43), specifically, in a case where recognition results different from each other are included in the plurality of recognition results based on each of the plurality of images, the determination unit 13 determines whether a difference between a highest degree of reliability and a second highest degree of reliability is equal to or more than a threshold value among degrees of reliability of each of the plurality of recognition results based on each of the plurality of images (S44). Note that, in a case where only two recognition results based on two images are acquired, processing of determining whether a difference in degree of reliability between the two recognition results is equal to or more than a threshold value is performed.

In a case where the difference is equal to or more than the threshold value (Yes in S44), the determination unit 13 determines the recognition result having the highest degree of reliability, as a final recognition result (S46).

On the other hand, in a case where the difference is less than the threshold value (No in S44), the determination unit 13 determines a final recognition result, based on a size of a region where a product (object) is present within each of the plurality of images (S45). Specifically, the determination unit 13 computes a size of a region where a product (object) is present within each of the plurality of images, based on an object detection result in S41, and determines a recognition result based on an image whose size is largest, as a final recognition result.

Next, the determination unit 13 outputs the determined final recognition result (S48).

Thereafter, similar processing is repeated.

Other configurations of the processing apparatus 10 are similar to those of the first to third example embodiments.

In the processing apparatus 10 according to the present example embodiment described above, an advantageous effect similar to that of the first to third example embodiments is achieved. Further, in the processing apparatus 10 according to the present example embodiment, it is possible to reduce the number of times of performing processing of computing a size of a region where a product (object) is present within each of a plurality of images, and processing of determining a final recognition result, based on a result of the computation. Consequently, processing load on a computer is reduced.

### Fifth Example Embodiment

A processing apparatus 10 according to a present example embodiment is different from that of the first to fourth example embodiments in details on processing of determining a final recognition result, based on a size of a region where a product is present within each of a plurality of images.

A determination unit 13 computes an evaluation value of a recognition result of each of a plurality of images, based on a degree of reliability of a recognition result, and a size of a region where a product is present within an image, and determines a final recognition result, based on the evaluation value. The determination unit 13 computes a higher evaluation value, as a degree of reliability of a recognition result increases, and a size of a region where a product is present within an image increases. Further, the determination unit 13 determines a recognition result having a highest evaluation value, as a final recognition result. Details on a computation method (such as a formula) of an evaluation value is a design matter.

Note that, the determination unit 13 may further compute the above-described evaluation value, based on a weighted value of each of a plurality of cameras set in advance. A camera for easily generating an image useful for product recognition has a higher weighted value. Further, an evaluation value increases in a recognition result of an image generated by a camera having a higher weighted value.

For example, a weighted value increases in a camera installed at a position and in an orientation capable of easily generating an image useful for product recognition. An image useful for product recognition is an image including a characteristic portion (outer surface of a package) of an external appearance of a product, an image in which a product is not hidden (an area of a hidden portion is less) by a part (such as a hand) of a physical body of a customer or another obstacle, and the like.

In addition to the above, a weighted value of a camera may be determined, based on, for example, a specification or the like of the camera. A camera having a high specification easily generates an image useful for product recognition.

Note that, herein, it is assumed that a higher evaluation value is computed, as a degree of reliability of a recognition result increases, as a size of a region where a product is present within an image increases, and as a weighted value of a camera increases; however, a lower evaluation value may be computed, as a degree of reliability of a recognition result increases, as a size of a region where a product is present within an image increases, and as a weighted value of a camera increases. In this case, the determination unit 13 determines a recognition result having a lowest evaluation value, as a final recognition result.

For example, processing of S13 in the flowchart in FIG. 6, processing of S24 in the flowchart in FIG. 7, processing of S33 in the flowchart in FIG. 8, processing of S45 in the flowchart in FIG. 9, and the like can be replaced by the above-described processing of the determination unit 13.

Other configurations of the processing apparatus 10 are similar to those of the first to fourth example embodiments.

In the processing apparatus 10 according to the present example embodiment described above, an advantageous effect similar to that of the first to fourth example embodiments is achieved. Further, in the processing apparatus 10 according to the present example embodiment, a final recognition result can be determined, taking into consideration not only a size of a region where a product is present within an image, but also a degree of reliability of a recognition result, evaluation (a weighed value based on a position, an orientation, a specification, and the like) and the like of a camera that has generated each image.

Consequently, accuracy of product recognition is improved.

### Sixth Example Embodiment

In a present example embodiment, a product picked up by a customer is photographed by two cameras. For example, a configuration in FIGS. 3 to 5 may be adopted.

Further, an acquisition unit 11 acquires a first image generated by one of the two cameras (hereinafter, a “first camera”), and a second image generated by the other of the two cameras (hereinafter, a “second camera”).

A determination unit 13 computes L1/L2 being a ratio between a size L1 of a region where a product (object) is present within the first image, and a size L2 of a region where the product (object) is present within the second image.

Further, in a case where L1/L2 is equal to or more than a threshold value set in advance, the determination unit 13 determines a recognition result based on the first image, as a final recognition result.

On the other hand, in a case where L1/L2 is less than the threshold value, the determination unit 13 determines a recognition result based on the second image, as a final recognition result.

The threshold value of the ratio can be set to a value different from 1. For example, in a case where the first camera is a camera capable of easily generating an image useful for product recognition, as compared with the second camera, the threshold value of the ratio becomes a value smaller than 1. On the other hand, in a case where the second camera is a camera capable of easily generating an image useful for product recognition, as compared with the first camera, the threshold value of the ratio becomes a value larger than 1. “An image useful for product recognition” is as described in the fourth example embodiment.

Other configurations of the processing apparatus 10 are similar to those of the first to fifth example embodiments.

In the processing apparatus 10 according to the present example embodiment described above, an advantageous effect similar to that of the first to fifth example embodiments is achieved. Further, in the processing apparatus 10 according to the present example embodiment, a final recognition result can be determined, taking into consideration evaluation (a weighed value based on a position, an orientation, a specification, and the like) and the like of a camera that has generated each image. Consequently, accuracy of product recognition is improved.

Note that, in the present specification, “acquisition” includes at least one of “acquisition of data stored in another apparatus or a storage medium by an own apparatus (active acquisition)”, based on a user input, or based on a command of a program, for example, requesting or inquiring another apparatus and receiving, accessing to another apparatus or a storage medium and reading, and the like, “input of data to be output from another apparatus to an own apparatus (passive acquisition)”, based on a user input, or based on a command of a program, for example, receiving data to be distributed (or transmitted, push-notified, or the like), and acquiring by selecting from received data or information, and “generating new data by editing data (such as converting into a text, rearranging data, extracting a part of pieces of data, and changing a file format) and the like, and acquiring the new data”.

While the invention of the present application has been described with reference to the example embodiments (and examples), the invention of the present application is not limited to the above-described example embodiments (and examples). A configuration and details of the invention of the present application may be modified in various ways comprehensible to a person skilled in the art within the scope of the invention of the present application.

A part or all of the above-described example embodiments may also be described as the following supplementary notes, but is not limited to the following.

1. A processing apparatus including:
an acquisition unit that acquires an image generated by a plurality of cameras for photographing a product picked up by a customer;
a recognition unit that recognizes the product, based on each of a plurality of images generated by the plurality of cameras; and
a determination unit that determines the final recognition result, based on a plurality of recognition results based on each of the plurality of images, and a size of a region where the product is present within each of the plurality of images.

2. The processing apparatus according to supplementary note 1, wherein
the determination unit,
in a case where a difference between a highest degree of reliability and a second highest degree of reliability is less than a threshold value among degrees of reliability of each of the plurality of recognition results, determines the final recognition result, based on a size of a region where the product is present within each of the plurality of images, and,
in a case where a difference between a highest degree of reliability and a second highest degree of reliability is equal to or more than the threshold value among degrees of reliability of each of the plurality of recognition results, determines a recognition result having a highest degree of reliability, as the final recognition result.

3. The processing apparatus according to supplementary note 1 or 2, wherein
the determination unit,
   in a case where recognition results different from each other are included in the plurality of recognition results, determines the final recognition result, based on a size of a region where the product is present within each of the plurality of images, and,
   in a case where the plurality of recognition results match, determines a matched recognition result, as the final recognition result.

4. The processing apparatus according to any one of supplementary notes 1 to 3, wherein,
in a case where the determination unit determines the final recognition result, based on a size of a region where the product is present within each of the plurality of images, the determination unit determines a recognition result based on an image in which a region where the product is present is largest, as the final recognition result.

5. The processing apparatus according to any one of supplementary notes 1 to 3, wherein
a plurality of cameras for photographing a product picked up by a customer are two cameras,
the acquisition unit acquires a first image generated by one of the two cameras, and a second image generated by the other of the two cameras, and
the determination unit,
   in a case where L1/L2 being a ratio between a size L1 of a region where the product is present within the first image, and a size L2 of a region where the product is present within the second image is equal to or more than a threshold value, determines a recognition result based on the first image, as the final recognition result, and,
   in a case where L1/L2 is less than a threshold value, determines a recognition result based on the second image, as the final recognition result.

6. The processing apparatus according to supplementary note 5, wherein
the threshold value is a value different from 1.

7. The processing apparatus according to any one of supplementary notes 1 to 3, wherein
the determination unit determines the final recognition result, based on an evaluation value computed based on a degree of reliability of a recognition result, and a size of a region where the product is present within an image.

8. The processing apparatus according to supplementary note 7, wherein the determination unit further computes the evaluation value, based on a weighted value of each of the plurality of cameras.

9. A processing method including,
by a computer:
acquiring an image generated by a plurality of cameras for photographing a product picked up by a customer;
recognizing the product, based on each of a plurality of images generated by the plurality of cameras; and
determining the final recognition result, based on a plurality of recognition results based on each of the plurality of images, and a size of a region where the product is present within each of the plurality of images.

10. A program causing a computer to function as:
an acquisition unit that acquires an image generated by a plurality of cameras for photographing a product picked up by a customer;
a recognition unit that recognizes the product, based on each of a plurality of images generated by the plurality of cameras; and
a determination unit that determines the final recognition result, based on a plurality of recognition results based on each of the plurality of images, and a size of a region where the product is present within each of the plurality of images.

What is claimed is:

1. A processing apparatus comprising:
at least one memory configured to store one or more instructions; and
at least one processor configured to execute the one or more instructions to:
acquire an image generated by a plurality of cameras for photographing a product picked up by a customer;
recognize the product, based on each of a plurality of images generated by the plurality of cameras; and
determine a final recognition result, based on a plurality of recognition results based on each of the plurality of images, and a size of a region where the product is present within each of the plurality of images.

2. The processing apparatus according to claim 1, wherein
the processor is further configured to execute the one or more instructions to:
in a case where a difference between a highest degree of reliability and a second highest degree of reliability is less than a threshold value among degrees of reliability of each of the plurality of recognition results, determine the final recognition result, based on a size of a region where the product is present within each of the plurality of images, and,
in a case where a difference between a highest degree of reliability and a second highest degree of reliability is equal to or more than the threshold value among degrees of reliability of each of the plurality of recognition results, determine a recognition result having a highest degree of reliability, as the final recognition result.

3. The processing apparatus according to claim 1, wherein
the processor is further configured to execute the one or more instructions to:
in a case where recognition results different from each other are included in the plurality of recognition results, determine the final recognition result, based on a size of a region where the product is present within each of the plurality of images, and,
in a case where the plurality of recognition results match, determine a matched recognition result, as the final recognition result.

4. The processing apparatus according to claim 1, wherein,
the processor is further configured to execute the one or more instructions to:
in a case where determining the final recognition result, based on a size of a region where the product is present within each of the plurality of images, determine a recognition result based on an image in which a region where the product is present is largest, as the final recognition result.

5. The processing apparatus according to claim 1, wherein
a plurality of cameras for photographing a product picked up by a customer are two cameras,
the processor is further configured to execute the one or more instructions to:
acquire a first image generated by one of the two cameras, and a second image generated by the other of the two cameras, and
in a case where L1/L2 being a ratio between a size L1 of a region where the product is present within the first image, and a size L2 of a region where the product is present within the second image is equal to or more than a threshold value, determine a recognition result based on the first image, as the final recognition result, and,
in a case where L1/L2 is less than a threshold value, determine a recognition result based on the second image, as the final recognition result.

6. The processing apparatus according to claim 5, wherein
the threshold value is a value different from 1.

7. The processing apparatus according to claim 1, wherein the processor is further configured to execute the one or more instructions to determine the final recognition result, based on an evaluation value computed based on a degree of reliability of a recognition result, and a size of a region where the product is present within an image.

8. The processing apparatus according to claim 7, wherein the processor is further configured to execute the one or more instructions to compute the evaluation value, based on a weighted value of each of the plurality of cameras.

9. A processing method comprising,
by a computer:
acquiring an image generated by a plurality of cameras for photographing a product picked up by a customer;
recognizing the product, based on each of a plurality of images generated by the plurality of cameras; and
determining a final recognition result, based on a plurality of recognition results based on each of the plurality of images, and a size of a region where the product is present within each of the plurality of images.

10. A non-transitory storage medium storing a program causing a computer to:
acquire an image generated by a plurality of cameras for photographing a product picked up by a customer;
recognize the product, based on each of a plurality of images generated by the plurality of cameras; and
determine a final recognition result, based on a plurality of recognition results based on each of the plurality of images, and a size of a region where the product is present within each of the plurality of images.
